(19) United States
(12) Patent Application Publication
(10) Pub. No.: US 2010/0090355 A1
(43) Pub. Date: Apr. 15, 2010

(54) LIQUID TREATMENT DEVICE

(76) Inventor: Neil Weatherill, Leeds (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/525,371

(22) PCT Filed: Feb. 1, 2008
(86) PCT No.: PCT/GB2008/000333

§ 371 Date: Dec. 10, 2009

(30) Foreign Application Priority Data
Feb. 1, 2007 (GB) 0701889.8
Jul. 21, 2007 (GB) 0714267.2

(51) Int. Cl. B01F 3/04; B01F 13/00; C12H 1/00

(52) U.S. Cl. 261/26; 261/119.1; 261/121.1; 261/36.1

(57) ABSTRACT

The invention relates to a device which can be used to aerate a body of liquid such as wine. The device is provided to be portable and to be used with a body of liquid which is held within a container from which the liquid can be directly consumed.

The invention to which this application relates is a device which can be used in conjunction with a liquid, typically when the liquid is held in a container of a type from which the liquid can be consumed by a person. The device is provided to be at least partially immersed in the liquid when in the container to allow the liquid to be treated in a manner generally regarded as improving the quality of the same.

With certain liquids, specifically, but not necessarily exclusively, wine, it is regarded as advantageous to expose the same to air and aerate the same prior to consumption. It is generally held by wine aficionados that this will increase the taste and pleasure obtained when drinking the liquid.

All red wines and some white wines benefit from being aerated, also referred to as breathing, before they are drunk. Normally, wines can only be breathed properly through decanting or by using a relatively large device that is used in conjunction with a wine bottle to aerate and breathe the wine when it is in the bottle.

These devices, known as wine breathers, are provided to expose wine to the air when the wine is in the bottle such that the wine can be treated prior to being poured into a glass for consumption therefrom. Alternatively, the wine can be poured through a wine breather device prior to entering, the glass. In either case the known devices are relatively bulky and expensive and are therefore generally only available for use in a commercial premises for use by a barman or sommelier where are a large quantity of wine is being consumed or in a person's home and therefore they are not available on a widescale basis.

This therefore restricts the use of such devices and prevents the advantages of breathing wine from being obtained.

The aim of the present invention is to provide a device of a form which allows the same to be effective in aerating and breathing a smaller quantity of liquid than is conventionally the case, and preferably to provide the device in a relatively portable form therefore rendering the same more readily available for use.

In a first aspect of the invention there is provided a device which is provided to be at least partially immersed in a body of liquid held in a container from which the liquid can be consumed, wherein said device includes means to pass at least a portion of the liquid and/or gas through at least part of the device so as to aerate the liquid prior to consumption.

In one embodiment the liquid is passed through one or a plurality of passages in the device. Typically the liquid is drawn in from a location in the body of liquid lower than the location at which the liquid leaves the device.

In one embodiment the liquid moved through the device is moved to or adjacent to the surface or meniscus of the body of liquid so as to be exposed to air.

In one embodiment the device is usable with a container, such as a glass or cup, from which the liquid can be directly consumed. Typically the device is portable on the person and, in one embodiment, can be a similar shape and size as a pen and may be carried in a similar manner to a pen on the person.

In one embodiment the liquid is drawn into the device via a drive assembly which draws the liquid in and passes the same along the channels to reach one or more ports from which the liquid exits the device.

In one embodiment the drive assembly includes at least one power source connected to drive a motor. In one embodiment the drive motor is connected to rotate a shaft on which one or more impellers are mounted.

Typically the device is hand held when in use and serves to aerate the liquid which, in one embodiment, is wine. Typically, the liquid to be consumed is poured into the container and the device can be placed into the liquid in the container to aerate the same.

In one embodiment the device is provided to introduce air into the body of liquid. In this embodiment air is drawn into the device from a location on the device which is not immersed, into the device and then passes through the device, to exit the same at a location on the device which is immersed in the liquid.

In one embodiment the device is provided with a switch to switch the device on and off, said device operable by the user. In an alternative embodiment the device is provided with sensing means located such that when the device is in position for use, the sensing means are located in the liquid and the device is switched on automatically by the liquid completing the electrical circuit. Also, when the sensing means are free of the liquid, the device is switched off.

Typically the device, in whichever embodiment, includes a housing manufactured from food grade material.

In one embodiment, at least the portion of the device provided to be immersed in liquid when in use is made from a metal such as stainless steel, or a precious metal.

It is the intention of this invention to enable wines to be breathed in the container they are to be consumed from by means of the portable hand held device.

In one embodiment the device includes a power source and a motor that draws wine up from the tip of the device when it is placed in a body of liquid and the liquid is moved to exit the device out on the surface of the body of liquid or adjacent thereto in the container. The movement of liquid induced by the device causes the liquid to circulate from the bottom of the container towards the top of the body of liquid, thereby exposing more of the liquid to the air at the surface of the liquid and thereby breathing the liquid.

In one aspect of the invention there is provided a device for the aeration of liquid, said device comprising a portion which is provided with an end to be immersed in the liquid, said end provided with at least one entry port, and at a location spaced from said end, on the body of the device, there is provided at least one exit port, a passage connects said entry and exit ports and movement means are provided to allow the movement of liquid from the body of liquid through the entry ports and to the exit ports and back into the body of liquid to aerate the same.

In a yet further aspect of the invention there is provided a device for use to aerate or breathe a body of liquid, said device including a power source and a movement means which allows fluid to be moved through the device and introduced into the body of liquid at a location spaced from that at which the fluid enters the device so as to aerate the same.

In one embodiment the fluid is liquid which enters the device at a location in the body of liquid lower than that at which the liquid enters, the body of liquid when the device is positioned in the body of liquid. Typically the movement of liquid induced by the device causes the body of liquid to circulate from the bottom of the container to the top thereby exposing more of the liquid to the air at the surface of the body of liquid and thereby breathing the liquid.

Preferably the liquid can be directly consumed from the container in which the body of liquid is aerated. This therefore means that relatively smaller quantities of liquid than conventionally can be aerated at any given time. It also means that by providing the device in a portable format the device can be carried and used at a location at which the liquid is served and to be consumed. It also means that the device can be used when the body of liquid is held in a container from which the liquid can then be consumed without the need for the liquid to subsequently be transferred to another container for consumption.

Specific embodiments of the device will now be described with reference to the accompanying drawings wherein:

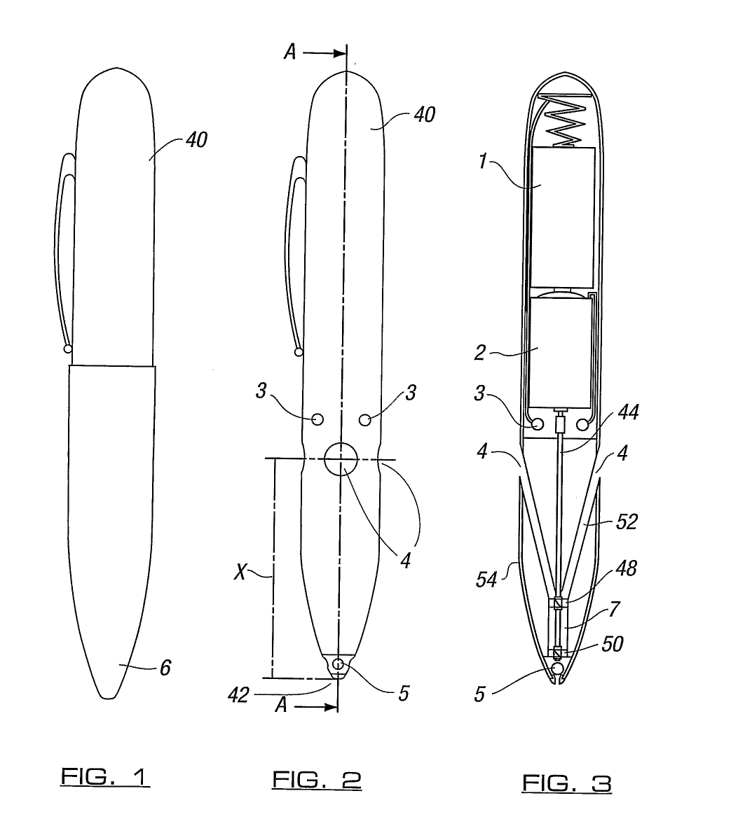

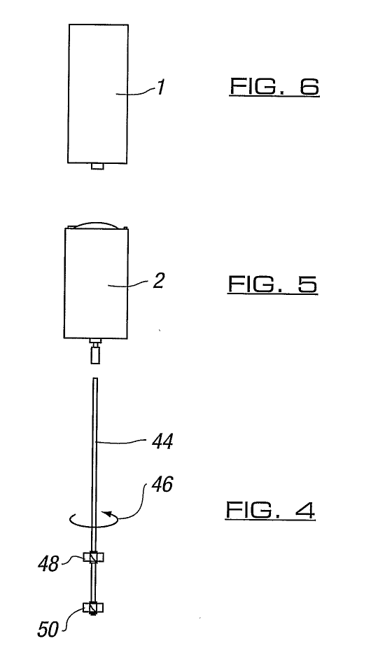

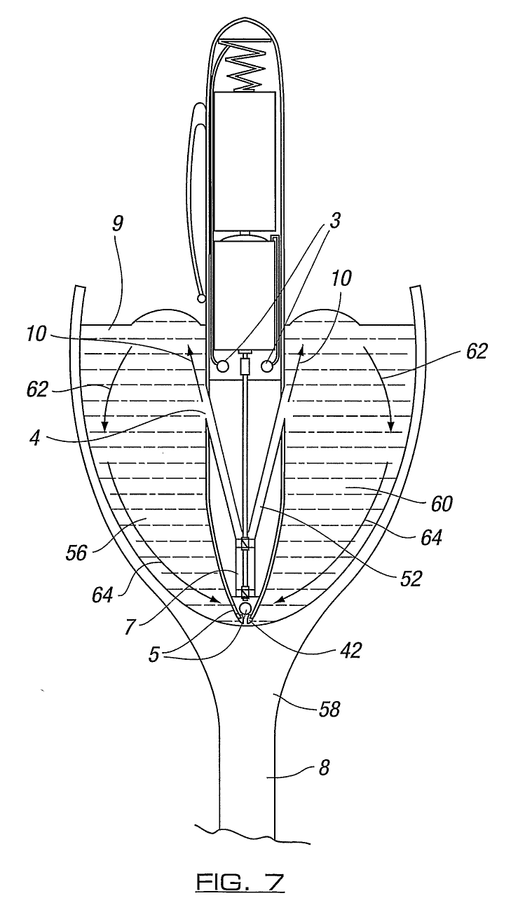

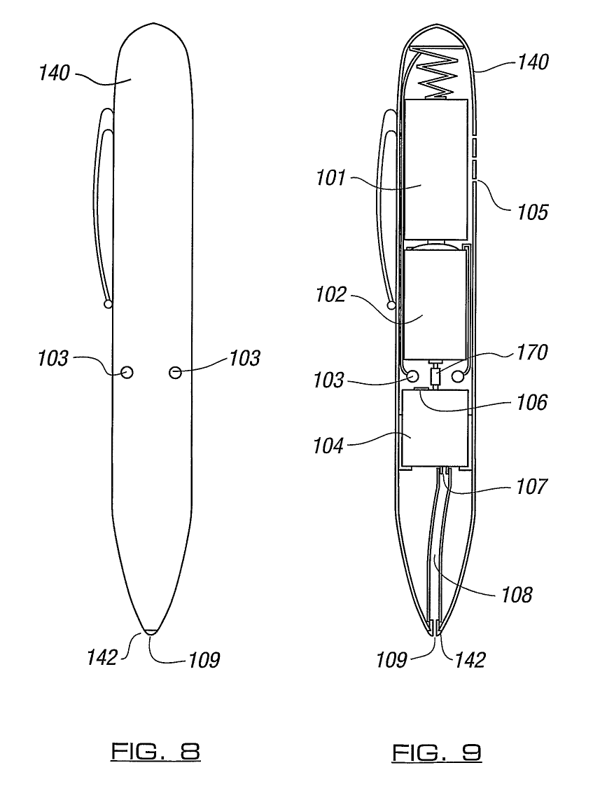

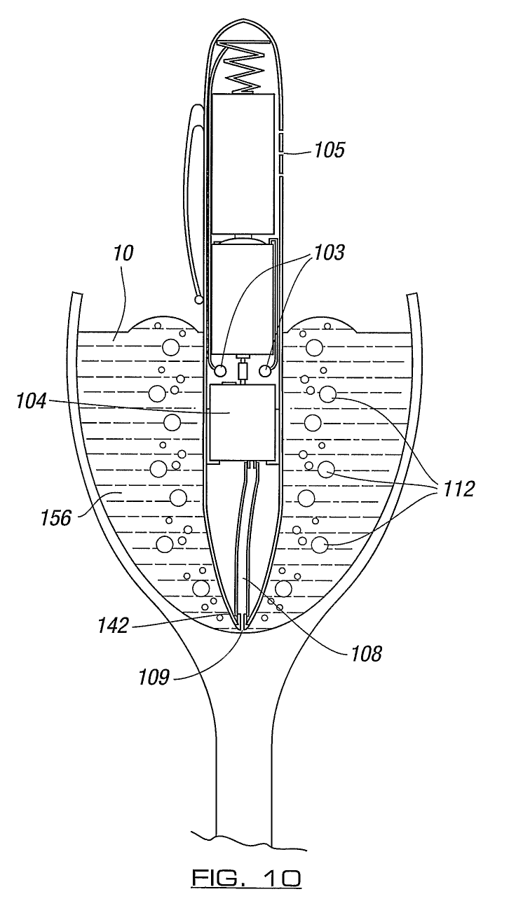

FIG. 1 shows a side view of one embodiment of a device in accordance with the invention.

FIG. 2 illustrates the device of FIG. 1 with a protective cap removed;

FIG. 3 illustrates a cross sectional view of the device of FIGS. 1 and 2;

FIG. 4-6 illustrate components of the movement means according to one embodiment of the device;

FIG. 7 illustrates the device in the embodiment of FIGS. 1-6, in use with a glass of liquid;

FIGS. 8 and 9 illustrate an alternative embodiment of the invention in elevation and sectional elevation respectively; and

FIG. 10 illustrates the embodiment of the device of FIGS. 8 and 9 in use.

Referring firstly to FIGS. 1 and 2, there is illustrated a device 40 in accordance with the first embodiment of the invention. In FIG. 1, the device 40 is shown with a protective end cap 6 in position and, in FIG. 2, the end cap 6 has been removed.

With the end cap removed, so a series of ports are visible. Entry ports 5, are provided at the tip 42 of one end of the device in this embodiment, and these ports are used to draw in the liquid from a surrounding body of liquid in which the device is placed, said liquid passing into the device and exiting the same via exit ports 4 which, it will be seen, are spaced a distance X from the tip 42.

Also shown, in this embodiment, are electrical sensors 3 which, when immersed in the liquid, utilise the liquid to complete an electrical, circuit between the same and hence complete a power circuit provided within the device body.

These sensors can be used to automatically turn the device on or off respectively when immersed or removed from the liquid.

FIG. 3 shows a cross-section side view along line A-A of the embodiment of the device 40. This pen shaped embodiment of the device includes a battery, 1, and an electric motor 2 connected to sensors 3.

In FIG. 3 it is shown how the power source and the battery 1 and motor 2, when connected together via the connection between the sensors 3, allows the drive of a shaft 44 connected to the motor 2. The shaft 44 is driven to rotate as indicated by arrow 46 in FIG. 4 and, mounted at the distal end of the shaft, are impellers 48, 50. These impellers are mounted in proximity to the port 5 so as to act to draw liquid through the entry ports 4 and hence through the passages 52 to the exit ports 4 via which the liquid exits the device.

In use, at least the end 54 of the device is required to be immersed in the liquid and the cross sectional view of FIG. 3 of the device is shown in FIG. 7 with the device in an in use position in a body of liquid in a glass from which the liquid can be consumed. Thus, it will be seen that the tip 42 of the device is positioned close to the bottom of the cavity 56 in the container, in this case in the form of a glass 58, in which the body of liquid 60 is held. Typically, the liquid will be wine but this is not necessarily the case and the device can be used with other liquids. The device is used, when operated, such that the rotation of the impellers, draws liquid from the body of liquid into the device through the ports 5 and moves along the passages 52 to exit the device via ports 4 and move, initially, in the direction of arrows 10. The continued movement of the expelled liquid through the body of liquid, causes a rotational movement effect to be created as is illustrated by arrows 62 and 64 around the body of liquid and hence around the device which will typically be mounted centrally of the body of liquid.

The device is typically hand held and is preferably held in the body of the liquid such that the exit apertures 4 are at or near to the top surface of the body of liquid which is exposed to air. This therefore ensures that the expelled liquid from the device, comes into contact with the air and therefore causes the aerating effect to be created.

As the device is inserted into the liquid the sensors 3 turn the device on and pump the liquid from the tip of the device, thereby causing the circular movement throughout the body of liquid in the glass.

Turning now to FIGS. 8-10, there is illustrated an alternative embodiment of the invention in which there is provided a device 140 which in this case is not provided with a cap, but may be. In this case, at the tip 142, there is provided an exit aperture 109 leading, as shown in the cross section FIG. 9, to a channel 108. This channel leads to an air pump 104 which is powered to rotate via a shaft 170 which is connected to a motor 102 which in turn is connected to be powered by battery 101. Electrical sensors 103 are provided on the surface of the device such that when the same come into contact with liquid, the electrical connection is made between the power source and the motor to cause rotation of the shaft 170 and operation of the pump 104. The air pump includes an inlet 106 which allows air to enter the pump 104 and an exit 107 which is connected to the channel 108. The device is also provided with external apertures 105 which allow air to enter into the interior of the device and hence reach the inlet 106 to the air pump 104.

It will be appreciated that this embodiment of the device operates differently to that of the first embodiment but still achieves the aeration of the body of liquid and FIG. 10 illustrates the embodiment of FIGS. 8 and 9 in operation. In this case, the device is again positioned within the body of liquid 156 held in a container in the form of a glass but in this case, air is introduced into the body of liquid via the aperture 109 at the tip 142 of the device. The air is pumped towards the tip 142 by the air pump 104 which moves the air present within the device to the tip via the channel 108. This introduces air bubbles 112 into the wine and hence aerates the same.

It will therefore be appreciated that in both embodiments of the invention there is provided a device which can be hand held and portable and which can be used with respect to liquid held in a container from which the same is to be consumed. This is an important feature in that it allows the device to be used by an individual and, as such, the device is more readily available for use and hence the benefits of the same can be more readily achieved that is the case with the conventional devices which are for use with the entire bottle of wine.

1. A device provided to be at least partially immersed in a body of liquid held in a container from which the liquid can be consumed, wherein said device includes means to pass at least a portion of the liquid and/or gas through at least part of the device so as to aerate the liquid prior to consumption wherein liquid from the body of liquid is passed through one or a plurality of passages in the device.

2. A device according to claim 1 wherein the liquid is drawn from a location in the body of liquid lower than the location at which the liquid leaves the device.

3. A device according to claim 1 wherein liquid moved through the device exits the same at or adjacent to the surface or meniscus of the body of liquid.

4. A device according to claim 1 wherein the device is usable with a container from which the liquid can be directly consumed.

5. A device according to claim 1 wherein the device is portable on the person.

6. A device according to claim 1 wherein the liquid is drawn into the device by the operation of movement means located within the device.

7. A device according to claim 6 wherein the movement means includes at least one power source connected to drive a motor.

8. A device according to claim 7 wherein the motor is connected to rotate a shaft on which at least one impeller is mounted.

9. A device according to claim 1 wherein the liquid is wine.

10. A device according to claim 1 wherein the device is provided to introduce a gas into the body of liquid.

11. A device according to claim 10 wherein air is drawn into the device from a location on the device which is not immersed into the device and then passes through the device to exit the same at a location on the device which is immersed in the liquid.

12. A device according to claim 1 wherein the device includes a pump.

13. A device according to claim 1 wherein the device is provided with sensing means located such that when the device is in position for use, the sensing means are located in the liquid and the device is switched on automatically by the liquid completing the electrical circuit.

14. A device for the aeration of liquid, said device comprising a portion which is provided with an end to be immersed in the liquid, said end provided with at least one entry port, and at a location spaced from said end, on the body of the device, there is provided at least one exit port, a passage connects said entry and exit ports and movement means are provided to allow the movement of liquid from the body of liquid through the entry ports and to the exit ports and back into the body of liquid to aerate the same.

15. A device according to claim 14 wherein the fluid is liquid which enters the device at a location in the body of liquid lower than that at which the liquid exits the device to return to the body of liquid when the device is positioned in the body of liquid, to cause the liquid to circulate from the bottom of the body of liquid to the top thereby exposing more of the liquid to the air at the surface of the body of liquid and thereby breathing the liquid.

16-23. (canceled)
